(19) United States
(12) Patent Application Publication
(10) Pub. No.: US 2026/0249795 A1
(43) Pub. Date: Aug. 27, 2026

(54) VEHICLE SYSTEM AND CONTROL METHOD OF VEHICLE SYSTEM

(71) Applicant: DENSO CORPORATION, Kariya-city (JP)

(72) Inventors: Sho MATSUMOTO, Kariya-shi (JP); Tomohisa KISHIGAMI, Kariya-shi (JP)

(21) Appl. No.: 19/544,195

(22) Filed: Feb. 19, 2026

(30) Foreign Application Priority Data
Feb. 21, 2025 (JP) 2025-027102

(51) Int. Cl. B60R 16/023; B60R 16/03; H04L 12/40; H04L 67/12

(52) U.S. Cl. CPC B60R 16/023; B60R 16/03; H04L 12/40; H04L 67/12; H04L 2012/40273

(57) ABSTRACT

A vehicle system includes multiple control devices mounted on a vehicle. The multiple control devices include a lower layer control device, an upper layer control device having a relay control unit for turning on or off a relay circuit provided in a power supply line of the lower layer control device, and a communication partner control device performing a communication with the lower layer control device. The upper layer control device is configured to, in response to a communication between the communication partner control device and the lower layer control device for which the relay circuit has been turned on being interrupted for a predetermined period of time, turn off the relay circuit using the relay control unit and then turn on the relay circuit using the relay control unit.

### CROSS REFERENCE TO RELATED APPLICATION

The present application claims the benefit of priority from Japanese Patent Application No. 2025-027102 filed on February 21, 2025. The entire disclosure of the above application is incorporated herein by reference.

### TECHNICAL FIELD

The present disclosure relates to a vehicle system including multiple control devices mounted on a vehicle, and also relates to a control method of the vehicle system.

### BACKGROUND

Conventionally, a vehicle system is configured to, in response to each of multiple electronic control units detecting another one of the multiple electronic control units is operating abnormally, transmit a reset signal to the electronic control unit which operates abnormally.

### SUMMARY

According to an aspect of the present disclosure, a vehicle system includes multiple control devices mounted on a vehicle. The multiple control devices include at least one lower layer control device and at least one upper layer control device. The at least one upper layer control device has a relay control unit that turns on or turns off a relay circuit provided in a power supply line of the at least one lower layer control device. The multiple control devices further include at least one communication partner control device with which the at least one lower layer control device is communicatively connected via a communication bus. The at least one upper layer control device may be configured to, in response to a communication between the at least one communication partner control device and the at least one lower layer control device for which the relay circuit has been turned on being interrupted for a predetermined period of time, turn off the relay circuit using the relay control unit and then turn on the relay circuit using the relay control unit.

### BRIEF DESCRIPTION OF DRAWINGS

Features of the present disclosure will become apparent from the following detailed description made with reference to the accompanying drawings. In the drawings:

FIG. 1 is a diagram showing an exemplary configuration of a vehicle system according to a first embodiment of the present disclosure;

FIG. 2 is a diagram illustrating an example of an NM message and a method for implementing partial networking using the NM message;

FIG. 3 is a flowchart showing a process executed by an upper layer ECU according to the first embodiment of the present disclosure;

FIG. 4 is a flowchart showing a process executed by a first intermediate layer ECU and a second intermediate layer ECU according to the first embodiment of the present disclosure;

FIG. 5 is a flowchart showing a process executed by a first to a third lower layer ECUs according to the first embodiment of the present disclosure;

FIG. 6 is a diagram showing an exemplary configuration of a vehicle system according to a second embodiment of the present disclosure;

FIG. 7 is a flowchart showing a process executed by an upper layer ECU in addition to the flowchart shown in FIG. 3 according to a second embodiment of the present disclosure;

FIG. 8 is a flowchart showing a process executed by a first and a second intermediate layer ECUs according to the second embodiment of the present disclosure;

FIG. 9 is a flowchart showing a process executed by a first to third intermediate layer ECUs according to the second embodiment of the present disclosure; and

FIG. 10 is a flowchart showing a process executed by a first to third lower layer ECUs according to a third embodiment of the present disclosure.

### DETAILED DESCRIPTION

In recent years, in order to reduce power consumption in vehicle systems, partial networking has become common. In the partial networking, only electronic control units (ECUs) that need to operate are set to operation states, while the remaining ECUs are kept in sleep states.

The partial networking may be implemented as follows. First, ECUs are classified into multiple clusters according to their functions. Each ECU has cluster setting information that indicates the cluster into which it is classified. Each ECU receives a network management (hereinafter referred to as NM) message including activation target cluster information indicating the cluster to be activated. When the cluster to which each ECU belongs matches the cluster indicated by the activation target cluster information, the ECU is activated and switched to an operation state. When the cluster to which each ECU belongs does not match the cluster indicated by the activation target cluster information, the ECU maintains a sleep state. As a result, only the ECUs are required to perform predetermined functions are activated, while remaining ECUs are kept in the sleep states.

For example, in a case where the communication interface of an ECU receives an NM message and determines whether the cluster to which own ECU belongs matches the cluster indicated by the activation target cluster information. When the cluster setting information is lost or corrupted, the ECU may not be activated by the NM message. Alternatively, even when the ECU is in an operation state, if some abnormality occurs in the ECU, such as a control failure of CPU, the ECU may fail to perform normal operation.

In a related art, a reset signal is transmitted to an ECU which performs an abnormal operation. As described above, when an activation of ECU is failed or the ECU fails to perform normal operation, the activation target ECU may fail to receive the reset signal. For this reason, in the related art, there remains a concern that the ECU may fail to reliably return to the normal operation.

According to an aspect of the present disclosure, a vehicle system includes multiple control devices mounted on a vehicle. The multiple control devices include at least one lower layer control device and at least one upper layer control device. The at least one upper layer control device has a relay control unit that turns on or turns off a relay circuit provided in a power supply line of the at least one lower layer control device. The multiple control devices further include at least one communication partner control device with which the at least one lower layer control device is communicatively connected via a communication bus. The at least one upper layer control device is configured to, in response to a communication between the at least one communication partner control device and the at least one lower layer control device for which the relay circuit has been turned on being interrupted for a predetermined period of time, turn off the relay circuit using the relay control unit and then turn on the relay circuit using the relay control unit.

According to another aspect of the present disclosure, a control method of a vehicle system is provided. The vehicle system includes multiple control devices mounted on a vehicle. The multiple control devices include at least one lower layer control device and at least one upper layer control device. The at least one upper layer control device has a relay control unit that turns on or turns off a relay circuit provided in a power supply line of the at least one lower layer control device. The multiple control devices further include at least one communication partner control device with which the at least one lower layer control device is communicatively connected via a communication bus. The control method of the vehicle system includes: determining whether a communication between the at least one communication partner control device and the at least one lower layer control device for which the relay circuit has been turned on is interrupted for a predetermined period of time; and in response to determining that the communication between the at least one communication partner control device and the at least one lower layer control device is interrupted for the predetermined period of time, turning off the relay circuit using the relay control unit and then turning on the relay circuit using the relay control unit.

In the vehicle system and the control method of the vehicle system according to the present disclosure, the upper layer control device has the relay control unit that turns on or off the relay circuit provided in the power supply line of the lower layer control device. When the communication between the communication partner control devices and the lower layer control device whose relay circuit is turned on is interrupted for the predetermined period of time, the upper layer control device turns off the relay circuit using the relay control unit, and then turns on the relay circuit.

The upper layer control device can detect the abnormality occurred in the lower layer control device, such as the activation failure of lower layer control device or the abnormal operation of the lower layer control device, based on the communication interruption occurred in the lower layer control device. In response to the interruption of communication occurred in the lower layer control device, the upper layer control device turns off the relay circuit, thereby temporarily stopping the power supply to the lower layer control device. Thereafter, the upper layer control device turns on the relay circuit to resume the power supply to the lower layer control device. This control can force the reset of lower layer control device. Therefore, the vehicle system and the control method of the vehicle system according to the present disclosure can reliably control the lower layer control device to return to the normal operation state when an abnormality is occurred in the lower layer control device.

Hereinafter, embodiments of a vehicle system and a control method of the vehicle system according to the present disclosure will be described with reference to the drawings. However, the present disclosure is not limited to the following embodiments, and various modifications described below are also included in the technical scope of the present disclosure. In addition to the following embodiments, various modifications can be made without departing from the spirit of the present disclosure. The embodiments and various modification examples can be combined as appropriate within the scope of the present disclosure without causing any technical contradiction. In the following description, the same or similar components may be denoted by the same reference symbols throughout the drawings, and the description thereof may be omitted. In addition, in a case where only a part of the configuration is referred to in an embodiment or modification example, the description in the foregoing embodiment may be applied to the remaining configuration.

### First Embodiment

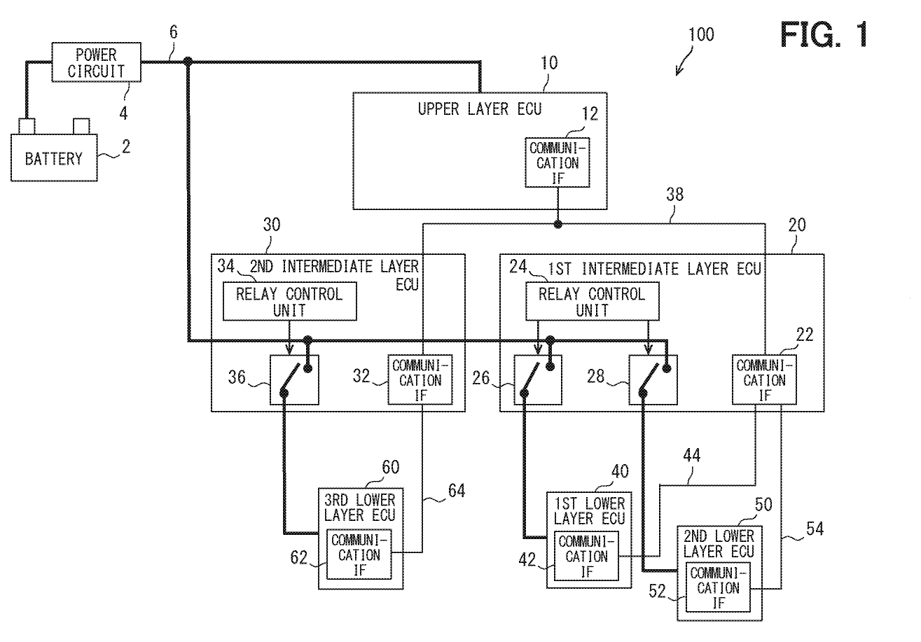

FIG. 1 is a diagram showing an exemplary configuration of a vehicle system 100 according to a first embodiment. The vehicle system 100 shown in FIG. 1 includes an upper layer ECU 10, first and second intermediate layer ECUs 20, 30 as upper layer control devices, and first to third lower layer ECUs 40, 50, 60 as lower layer control devices. ECU is an abbreviation for Electronic Control Unit. In the present embodiment, each of the upper layer ECU 10, the first and second intermediate layer ECUs 20, 30, and the first to third lower layer ECUs 40, 50, 60 is mounted on a vehicle. As well known, vehicles include passenger cars, motorcycles, transport vehicles, construction vehicles, agricultural vehicles, and the like.

The vehicle system 100 operates with power supply from a battery 2 mounted on the vehicle. The power supply by the battery 2 is provided via a power supply circuit 4 to the upper layer ECU 10, the first and second intermediate layer ECUs 20, 30, and the first to third lower layer ECUs 40, 50, 60 of the vehicle system 100. The power supply circuit 4 can convert, as necessary, the power supply voltage of the battery 2 mounted on the vehicle into the operation voltages for the upper layer ECU 10, the first and second intermediate layer ECUs 20, 30, and the first to third lower layer ECUs 40, 50, 60. The power supply line 6 for the first to third lower layer ECUs 40, 50, 60 is provided with first to third relay circuits 26, 28, 36, respectively. The first and second relay circuits 26, 28 are switched between ON states and OFF states by a first relay control unit 24 of the first intermediate layer ECU 20. The third relay circuit 36 is switched between ON state and OFF state by a second relay control unit 34 of the second intermediate layer ECU 30.

The first to third relay circuits 26, 28, 36 may be provided by semiconductor switches, such as metal oxide semiconductor field effect transistors (MOSFET) or insulated gate bipolar transistors (IGBT). Alternatively, each of the first to third relay circuits 26, 28, 36 may be implemented by a normal mechanical relay instead of the semiconductor switch. The first to third relay circuits 26, 28, 36 may be provided inside the first and second intermediate layer ECUs 20, 30 as shown in FIG. 1, or may be provided outside the first and second intermediate layer ECUs 20, 30.

The configuration of vehicle system 100 is not limited to the example shown in FIG. 1. For example, the number of upper layer ECUs 10 may be two or more instead of one. In this case, an intermediate layer ECU and a lower layer ECU may be arranged below each upper layer ECU. Two or more upper layer ECUs 10 may be communicably connected to one another. One of the intermediate layer ECUs 20, 30 may be configured to perform the functions of upper layer ECU 10, and the upper layer ECU 10 may be omitted. The number of intermediate layer ECUs 20, 30 arranged below the upper layer ECU 10 may be other than two, that is, may be one, three or more. For the lower layer ECUs 40, 50, 60, multiple lower layer ECUs may be connected to one relay circuit 26, 28, 36. One of the lower layer ECUs 40, 50, 60 may be configured to receive power supply directly from the power supply circuit 4 without going through the relay circuits 26, 28, 36.

Each of the upper layer ECU 10, the first and second intermediate layer ECUs 20, 30, and the first to third lower layer ECUs 40, 50, 60 may be implemented by a computer, which includes components, such as a processor, memory, and storage. For example, the processor is a CPU (Central Processing Unit), an MPU (Micro Processing Unit), a GPU (Graphics Processing Unit), or a DFP (Data Flow Processor), each of which is capable of executing a predetermined process according to a program. The memory is a volatile storage medium, such as a RAM (Random Access Memory), that temporarily stores results of arithmetic processing executed by the processor. The storage includes non-volatile storage media such as flash memory and ROM (Read Only Memory). The storage stores various data and programs to be executed by the processor.

The upper layer ECU 10, the first and second intermediate layer ECUs 20, 30, and the first to third lower layer ECUs 40, 50, 60 are further provided with communication interfaces (that is, communication IFs) 12, 22, 32, 42, 52, 62 for communicating with other ECUs via communication buses 38, 44, 54, 64.

The communication IF 12 of the upper layer ECU 10 is connected to the communication IFs 22, 32 of the first and second intermediate layer ECUs 20, 30 via the communication bus 38. The first and second intermediate layer ECUs 20, 30 can also communicate with one another via the communication bus 38. The communication bus that connects the upper layer ECU 10 with the first and second intermediate layer ECUs 20, 30 may be provided separately from the communication bus that connects the first and second intermediate layer ECUs 20, 30 with one another.

The communication IF 22 of the first intermediate layer ECU 20 is connected to the communication IF 42 of the first lower layer ECU 40 via a communication bus 44. The communication IF 22 of the first intermediate layer ECU 20 is connected to the communication IF 52 of the second lower layer ECU 50 via a communication bus 54. The communication IF 42 of the first lower layer ECU 40 and the communication IF 52 of the second lower layer ECU 50 may be connected to the communication IF 22 of the first intermediate layer ECU 20 via a common communication bus. The communication IF 32 of the second intermediate layer ECU 30 is connected to the communication IF 62 of the third lower layer ECU 60 via a communication bus 64.

The vehicle system 100 can use CAN (registered trademark, the same applies hereinafter) as the communication protocol for enabling the respective communication IFs 12, 22, 32, 42, 52, 62 of the upper layer ECU 10, the first and second intermediate layer ECUs 20, 30, and the first to third lower layer ECUs 40, 50, 60 to communicate with one another. CAN is an abbreviation for Controller Area Network. It should be noted that the communication protocol is not limited to CAN. The vehicle system 100 can adopt various communication protocols such as Ethernet (registered trademark), LIN (Local Interconnect Network), FlexRay (registered trademark), and CAN-FD (CAN with Flexible Data Rate). For example, different communication protocols may be adopted for different communication buses 38, 44, 54, 64.

The upper layer ECU 10 can function as a domain controller that controls the first to third lower layer ECUs 40, 50, 60. The domain refers to units of functions when vehicle functions are broadly divided into, for example, a powertrain domain, a chassis domain, an advanced driver assistance domain, a body domain, a cockpit domain, and the like. For example, when the domain controller of the powertrain domain is the upper layer ECU 10, the first to third lower layer ECUs 40, 50, 60 include various ECUs for controlling the vehicle's powertrain, such as an engine ECU, a motor (inverter) ECU, a battery monitoring ECU, and a transmission ECU. When the domain controller of the body domain is the upper layer ECU 10, the first to third lower layer ECUs 40, 50, 60 include various ECUs for controlling the vehicle body, such as an authentication ECU, a door ECU, a window ECU, and a camera ECU.

The above is an example for dividing the functional domains. The domains divided in accordance with the functions may be different from the above-described example. Alternatively, the upper layer ECU 10 may function as an area controller that manages the control of the first and second intermediate layer ECUs 20, 30 and the first to third lower layer ECUs 40, 50, 60 arranged in each area of the vehicle (for example, front, rear, right, and left sides, and the like).

For example, as a domain controller, the upper layer ECU 10 determines whether the first to third lower layer ECUs 40, 50, 60 should be activated and operated based on various information, such as various sensor signals, switch signals, and signals obtained from other ECUs. When the upper layer ECU 10 determines that at least one of the lower layer ECUs 40, 50, 60 should be activated and operating, the upper layer ECU can activate the corresponding lower layer ECU 40, 50, 60 and switch the state of corresponding lower layer ECU to an operation state by transmitting a network management (hereinafter referred to as NM) message. The NM message is explained in more detail below.

The function of determining that the first to third lower layer ECUs 40, 50, 60 should be activated and operated and transmitting the NM message to activate the corresponding lower layer ECUs 40, 50, 60 may be performed by the first and second intermediate layer ECUs 20, 30 in addition to or instead of the upper layer ECU 10. When the vehicle is equipped with multiple upper layer ECUs and at least one intermediate layer ECU corresponding to each of the multiple upper layer ECUs, the NM message for activating the lower layer ECU 40, 50, 60 may be transmitted from another upper layer ECU or an intermediate layer ECU corresponding to another upper layer ECU.

Based on the various information described above, the upper layer ECU 10 determines whether the vehicle is under a situation in which the lower layer ECUs 40, 50, 60 may be required to be activated and operated (for example, the vehicle is in traveling state or in parked state). When the upper layer ECU 10 determines that the vehicle is under a situation in which the lower layer ECUs 40, 50, 60 may be required to be activated and operated, the upper layer ECU 10 instructs the first or second intermediate layer ECU 20, 30 to turn on the relay circuit 26, 28, 36 corresponding to the activation target lower layer ECU 40, 50, 60. When the upper layer ECU 10 determines that the vehicle is not under a situation in which the lower layer ECUs 40, 50, 60 may be required to be activated and operated, the upper layer ECU 10 may instruct the first or second intermediate layer ECUs 20, 30 to turn off the relay circuit 26, 28, 36 corresponding to the lower layer ECU 40, 50, 60.

For example, when at least one of the first to third lower layer ECUs 40, 50, 60 is used to unlock the vehicle doors based on a communication result with a mobile device (for example, a smart key or a smartphone) carried by the user while the vehicle is in parked state, the upper layer ECU 10 instructs the first and second intermediate layer ECUs 20, 30 to turn on the relay circuits 26, 28, 36 corresponding to the corresponding lower layer ECUs 40, 50, 60 while the vehicle is in parked state.

It is also possible for the first and second intermediate layer ECUs 20, 30, rather than the upper layer ECU 10, to determine whether the vehicle is under a situation in which the lower layer ECUs 40, 50, 60 may be required to be activated and operated. In this case, each of the first and second intermediate layer ECUs 20, 30 only need to determine whether the vehicle is under a situation in which the lower layer ECUs 40, 50, 60, which are connected to the respective relay circuits 26, 28, 36 that control turning on or turning off of the lower layer ECUs, may be required to be activated and operated.

As described above, the first and second intermediate layer ECUs 20, 30 respectively have, as one function, the first and second relay control units 24, 34 that control turning on or turning off of the relay circuits 26, 28, 36. Each of the first and second relay control units 24, 34 turns on or off the corresponding relay circuit(s) 26, 28, 36 based on an instruction from the upper layer ECU 10 or based on the determination result in the corresponding first or second intermediate layer ECU 20, 30.

In addition to the function of turning on or off the respective relay circuits 26, 28, 36, the first and second intermediate layer ECUs 20, 30 also function as communication relay devices for enabling two-way communication between ECUs connected to different communication buses 38, 44, 54, 64. For example, each of the first and second intermediate layer ECUs 20, 30 may be configured to relays the NM message received from one communication bus 38, 44, 54, 64 to the another communication bus 38, 44, 54, 64. When the communication protocol of the communication bus that receives the NM message is different from the communication protocol of the communication bus that transmits the NM message, each of the first and second intermediate layer ECUs 20, 30 also performs a protocol conversion. In addition to the NM messages for implementing the partial network, control messages including control related data are also exchanged between the first to third lower layer ECUs 40, 50, 60. The first and second intermediate layer ECUs 20, 30 also function as gateways for such control messages. This configuration enables smooth cooperative control by multiple lower layer ECUs belonging to the same cluster.

Each of the first to third lower layer ECUs 40, 50, 60 may be, for example, a control ECU that executes a control process to control a specific control target in a vehicle, a sensor ECU that calculates a specific physical quantity based on a detection signal detected by a sensor, or a drive ECU that outputs a drive signal to an actuator to drive the actuator. Each of the first and second intermediate layer ECUs 20, 30 turns on the relay circuit 26, 28, 36, corresponding to the lower layer ECU 40, 50, 60 to be activated and switched to the operation state. When each of the first to third lower layer ECUs 40, 50, 60 is switched to the operation state, the lower layer ECU performs predetermined process, such as control process for controlling a target object, a calculation process for calculating predetermined physical quantity based on the detection signal of the sensor, or a drive process for outputting drive signal for driving an actuator.

The first to third lower layer ECUs 40, 50, 60 each has cluster setting information (referred to as PNC setting information) that indicates the cluster to which the lower layer ECU belongs among the multiple clusters classified in advance. For example, the PNC setting information may be stored in a non-volatile storage medium of the first to third lower layer ECUs 40, 50, 60. In the operation state, each of the first to third lower layer ECUs 40, 50, 60 periodically transmits the NM message containing activation target cluster information (referred to as PN request information), which designates the cluster to which own ECU belongs as the activation target cluster while own ECU is executing a predetermined control process, calculation process, or a drive process. The clusters, PNC setting information and PN request information are described in detail below. When the execution of the predetermined control process, calculation process, drive process, or the like is completed, each of the first to third lower layer ECUs 40, 50, 60 stops transmission of the NM message.

The first to third lower layer ECUs 40, 50, 60 each switches to a sleep state in response to a predetermined period of time being elapsed from completing of the execution of predetermined control process, calculation process, or drive process, and no longer reception of an NM message including the PN request information that designates the cluster to which own ECU belong as the activation target cluster. As a result, the lower layer ECUs belonging to the same cluster switch from the operation states to the sleep states at approximately the same time. In the sleep state, the lower layer ECU is only capable of receiving NM messages and stops other functions to keep a low power consumption state.

In order to receive the NM message in the sleep state, the first to third lower layer ECUs each 40, 50, 60 is provided with the communication IF 42, 52, 62 that supports partial networking. For example, the first to third lower layer ECUs 40, 50, 60 each may set information of the cluster to which own ECU 40, 50, 60 belong as an activation condition in the corresponding communication IF 42, 52, 62 based on the PNC setting information stored in the non-volatile storage medium. Therefore, each communication IF 42, 52, 62 can determine whether the received NM message includes the PN request information that matches the cluster to which own ECU 40, 50, 60 belongs.

When each communication IF 42, 52, 62 determines that the received NM message includes the PN request information that matches the cluster to which the corresponding lower layer ECU 40, 50, 60 belongs, the communication IF activates the corresponding lower layer ECU 40, 50, 60 and switches the corresponding lower layer ECU to the operation state. When each communication IF 42, 52, 62 determines that the received NM message does not include the PN request information that matches the cluster to which the corresponding lower layer ECU 40, 50, 60 belongs, the communication IF keeps the corresponding lower layer ECU 40, 50, 60 in the sleep state.

The first to third lower layer ECUs 40, 50, 60 do not necessarily have to include communication IFs 42, 52, 62 that support the partial networking. In this case, when the NM message is received in the sleep sate of the lower layer ECU 40, 50, 60, the communication IF 42, 52, 62 is configured to activate the corresponding lower layer ECU 40, 50, 60. Then, the activated lower layer ECU 40, 50, 60 may determine whether the NM message includes the PN request information that matches the cluster to which own ECU belongs. When the lower layer ECU 40, 50, 60 determines that the NM message includes the PN request information that matches the cluster to which own ECU belongs, the lower layer ECU maintains the operation state. When the lower layer ECU 40, 50, 60 determine that the NM message does not include the PN request information that matches the cluster to which own ECU belongs, the lower layer ECU returns to the sleep state again.

The following will describe cluster, NM message, PNC setting information, and PNC request information. In the present embodiment, in order to implement the partial networking using the NM message, each of the first to third lower layer ECUs 40, 50, 60 is assigned with a cluster to which own lower layer ECU belongs among the multiple clusters classified in advance. The NM message includes PN request information, which is activation target cluster information indicating the cluster to be activated.

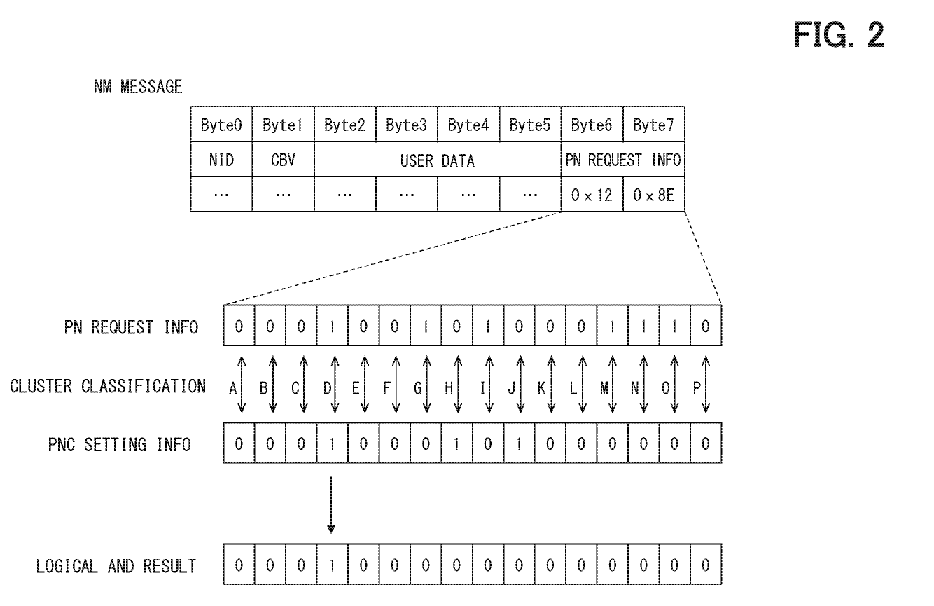

FIG. 2 shows an example of NM message. In the example shown in FIG. 2, the NM message includes data of bytes 0 to 7. Byte 0 contains node ID (NID). The node ID is an identifier preset for each of the upper layer ECU 10, the first and second intermediate layer ECUs 20, 30, and the first to third lower layer ECUs 40, 50, 60. The node ID enables identification of a transmission source of the NM message. Byte 1 contains control bit vector (CBV). The control bit vector contains data indicating whether partial networking is in use or not. When the control bit vector indicates the use of partial networking, the user data area of bytes 2 to 7 contains PN request information, which indicates the cluster to be activated.

In the example shown in FIG. 2, the control bit vector indicates the use of partial networking, and the PN request information is stored in bytes 6 and 7 of the user data area. The user data area of bytes 2 to 5 is usable to transmit any information such as an activation factor of ECU or information regarding normality or abnormality, for example. It should be noted that FIG. 2 shows only an example of the format of NM message. The NM message may be in another format as long as the NM message contains the PN request information. For example, the NID and CBV may be omitted.

The PN request information indicates, for each of multiple clusters classified in advance, a cluster to be activated, and a cluster that does not need to be activated. More specifically, in the example shown in FIG. 2, the ECUs are classified into 16 clusters in advance. The PN request information includes 16-bit data respectively corresponding to the 16 clusters. The 16-bit data of the PN request information is previously associated with the 16 clusters classified in advance. When each of the 16 bits of data in the PN request information is "0", it indicates that activation of the associated cluster is not necessary. When each of the 16 bits of data in the PN request information is "1", it indicates that activation of the associated cluster is necessary. The PN request information may indicate only the cluster to be activated. Hereinafter, the cluster to be activated is also referred to as activation target cluster. The PN request information may also indicate only the cluster that do not need to be activated.

FIG. 2 also shows an example of PNC setting information set for the lower layer ECUs. In the PNC setting information shown in FIG. 2, when the associated clusters are classified as A to P from left to right in FIG. 2, the PNC setting information in FIG. 2 indicates that the lower layer ECU having this PNC setting information belongs to the clusters D, H, and J. Since the lower layer ECU can perform various functions by executing a program, the lower layer ECU can belong to one or more clusters.

The first to third lower layer ECUs 40, 50, 60 can receive the NM message including the PN request information via the respective communication IFs 42, 52, 62. When receiving the NM message, the communication IF 42, 52, 62 determines whether the cluster to be activated by the PN request information included in the NM message matches the cluster included in the PNC setting information set for the corresponding lower layer ECU 40, 50, 60. For example, to determine the cluster matching, as shown in FIG. 2, the communication IF 42, 52, 62 compares the PN request information of the NM message with the PNC setting information of the corresponding lower layer ECU 40, 50, 60 bit by bit, and calculates a logical AND.

For example, in the example shown in FIG. 2, the activation target clusters requested by the PN request information are clusters D, G, I, M, N, and O. The clusters to which the lower layer ECU belongs are indicated by the PNC setting information as the clusters D, H, and J. In this case, for cluster D, the cluster requested to be activated by the PN request information of the NM message matches the cluster set in the PNC setting information. Therefore, the calculation result of logical AND is "1" in cluster D, as shown in FIG. 2.

When one of bits becomes "1" as a result of logical AND, the communication IF of the lower layer ECU in which the PNC setting information shown in FIG. 2 is set determines that activation of the corresponding lower layer ECU is requested. In response to this determination result, the communication IF activates the corresponding lower layer ECU and switches the corresponding lower layer ECU to the operation state. When the activation target lower layer ECU is already in the operation state, the lower layer ECU maintains the operation state. When all of the bits of logical AND are "0" without “1”, the communication IF determines that activation of the corresponding lower layer ECU is not requested. In this case, the communication IF does not activate the corresponding lower layer ECU, and maintains the sleep state. Alternatively, when the lower layer ECU is in the operation state, the lower layer ECU counts the elapsed time from last reception of the NM message requesting the activation of own ECU. When the lower layer ECU has completed a predetermined control process and the elapsed time during which the NM message has not been received reaches a predetermined period of time, the lower layer ECU switches from the operation state to the sleep state.

It is also possible to set the PNC setting information for the upper layer ECU 10 and/or the first and second intermediate layer ECUs 20, 30 so that the operation state and the sleep state can be switched by an NM message. Alternatively, the upper layer ECU 10 and/or the first and second intermediate layer ECUs 20, 30 may be configured to switch to the sleep state in response to elapse of a predetermined period of time from the last reception of NM message from another ECU.

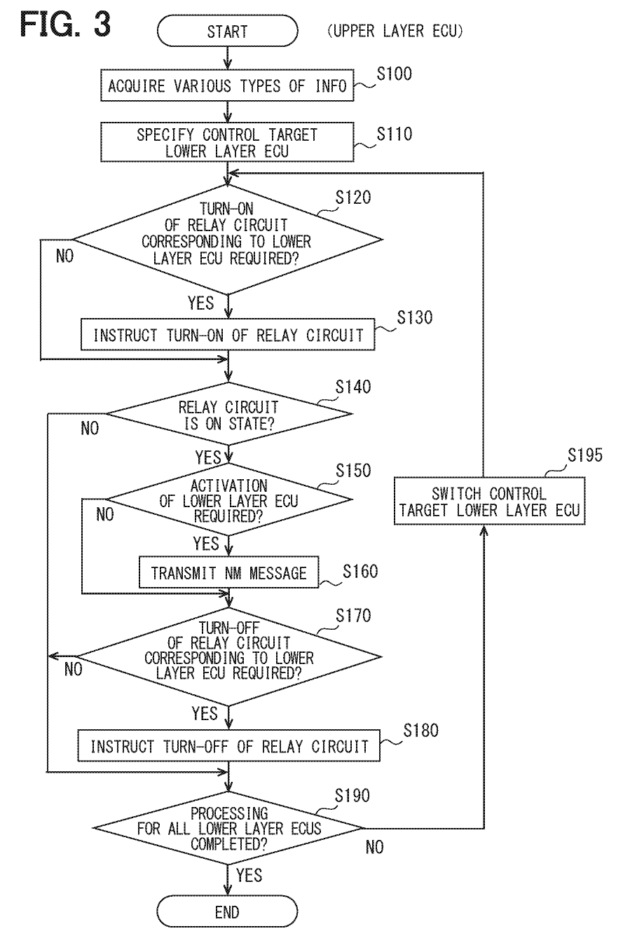

The following will describe an example of process executed by the upper layer ECU 10, the first and second intermediate layer ECUs 20, 30, and the first to third lower layer ECUs 40, 50, 60 in the vehicle system 100 according to the present embodiment with reference to the flowcharts of FIG. 3 to FIG. 5. The execution of process shown in the flowcharts of FIG. 3 to FIG. 5 by the upper layer ECU 10, the first and second intermediate layer ECUs 20, 30, and the first to third lower layer ECUs 40, 50, 60 correspond to the execution of a control method for controlling the vehicle system 100 in the present disclosure.

FIG. 3 is a flowchart showing an example of process executed by the upper layer ECU 10. The upper layer ECU 10 periodically executes the process shown in the flowchart of FIG. 3. In S100, the upper layer ECU 10 acquires various types of information, such as various sensor signals, switch signals, and signals acquired from another ECU. In S110, the upper layer ECU 10 identifies the lower layer ECU 40, 50, 60 to be processed, that is, a control target lower layer ECU.

In S120, the upper layer ECU 10 determines, based on the information acquired in S100, whether the current situation may require the control target lower layer ECU to switch to the operation state. In response to determining that the situation may require the control target lower layer ECU to switch to the operation state, the upper layer ECU 10 proceeds to S130. In response to determining that the situation does not require the control target lower layer ECU to switch to the operation state, the upper layer ECU 10 proceeds to S140.

In S130, the upper layer ECU 10 instructs the first or second intermediate layer ECU 20, 30 to turn on the relay circuit corresponding to the control target lower layer ECU. Then, the upper layer ECU 10 proceeds to S140.

In S140, the upper layer ECU 10 determines whether the relay circuit corresponding to the control target upper layer ECU is turned on. When the upper layer ECU 10 has instructed the relay circuit, which corresponds to the control target lower layer ECU, to be turned on in the current process shown in the flowchart of FIG. 3 or in a previous process, the upper layer ECU 10 can determine that the relay circuit corresponding to the control target lower layer ECU is turn-on state. In response to determining that the relay circuit is in turn-on state, the upper layer ECU 10 proceeds to S150. In response to determining that the relay circuit is not in turn-on state, the upper layer ECU 10 proceeds to S190.

In S150, the upper layer ECU 10 determines, based on the information acquired in S100, whether the control target lower layer ECU should be activated and switched to the operation state. In response to determining that the control target lower layer ECU should be activated and switched to the operation state, the upper layer ECU 10 proceeds to S160. In response to determining that activation of the control target lower layer ECU is not required, the upper layer ECU 10 proceeds to S170.

In S160, the upper layer ECU 10 activates the control target lower layer ECU by transmitting an NM message, and switches the control target lower layer ECU to the operation state. Then, the upper layer ECU 10 proceeds to S170.

In S170, the upper layer ECU 10 determines whether the control target lower layer ECU does not need to maintain the operation state, that is, whether the corresponding relay circuit should be turned off or not. In response to determining that the relay circuit should be turned off, the upper layer ECU 10 proceeds to S180. In response to determining that turn-off of the relay circuit is not required, the upper layer ECU 10 proceeds to S190.

In S180, the upper layer ECU 10 instructs the first or second intermediate layer ECU 20, 30 to turn off the relay circuit corresponding to the control target lower layer ECU. Then, the upper layer ECU 10 proceeds to S190. In S190, the upper layer ECU 10 determines whether the process executed in S120 to S180 described above is completed for all of the lower layer ECUs 40, 50, 60. In response to determining the process for all of the lower layer ECUs 40, 50, 60 has been completed, the upper layer ECU 10 ends the process shown in the flowchart of FIG. 3. In response to determining that the process for all of the lower layer ECUs 40, 50, 60 has not yet completed, the upper layer ECU 10 proceeds to S195.

In S195, the upper layer ECU 10 switches the control target lower layer ECU. Thereafter, the upper layer ECU 10 returns to S120 and repeats the process in S120 to S180 until the processes for all the lower layer ECUs 40, 50, 60 are completed.

The process shown in the flowchart of FIG. 3 may be configured to be executed by the first and second intermediate layer ECUs 20, 30 instead of the upper layer ECU 10.

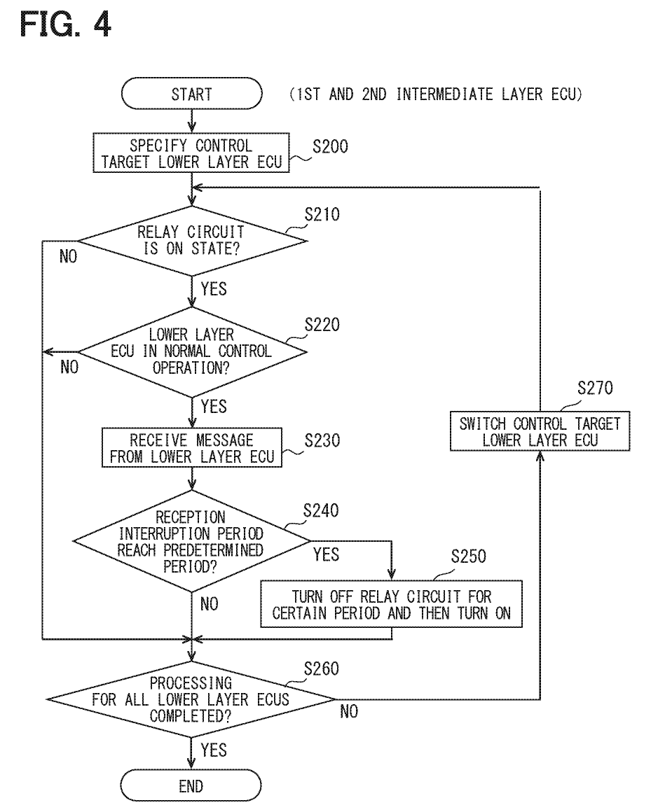

The following will describe a process executed by each of the first and second intermediate layer ECUs 20, 30. FIG. 4 is a flowchart showing an example of process executed by each of the first and second intermediate layer ECUs 20, 30. The first and second intermediate layer ECUs 20, 30 periodically execute the process shown in the flowchart of FIG. 4. In the following description, suppose that the first intermediate layer ECU 20 executes the process shown in the flowchart of FIG. 4 as representative.

In S200, the first intermediate layer ECU 20 identifies a control target lower layer ECU. The process of S200 may be omitted if there is only one lower layer ECU 60 whose power supply is controlled by the second intermediate layer ECU 30 via the relay circuit 36.

In S210, the first intermediate layer ECU 20 determines whether the relay circuit corresponding to the control target lower layer ECU is turn-on state. As described above, when the first intermediate layer ECU 20 is instructed by the upper layer ECU 10 to turn on the relay circuit, the first intermediate layer ECU 20 controls the relay control unit 24 to turn on the corresponding relay circuit. The first intermediate layer ECU 20 can determine whether the relay circuit corresponding to the control target lower layer ECU is in turn-on state based on the history of turn-on instructions for the relay circuit from the upper layer ECU, or the control history of the relay circuit by the relay control unit 24. In response to determining that the relay circuit corresponding to the control target lower layer ECU is in turn-on state, the first intermediate layer ECU 20 proceeds to S220. In response to determining that the relay circuit corresponding to the control target lower layer ECU is not in turn-on state, the first intermediate layer ECU 20 proceeds to S260.

In S220, the first intermediate layer ECU 20 determines whether the control target lower layer ECU is in normal operation state, which is a state the lower layer ECU performs a normal control. The process executed in S220 correspond to a determination unit of the present disclosure. For example, the first intermediate layer ECU 20 may determine that the control target lower layer ECU is in the normal operation state until elapse of a predetermined period of time. The predetermined period of time may be set from turn-on time of the relay circuit corresponding to the control target lower layer ECU to a preset time at which the lower layer ECU is estimated to complete the execution of predetermined process. The first intermediate layer ECU 20 also has the PNC setting information indicating the cluster to which the control target lower layer ECU belongs. The first intermediate layer ECU 20 may determine that the control target lower layer ECU is in the normal operation state while receiving NM messages including PN request information that designates the cluster to which the control target lower layer ECU belongs as the activation target cluster. In response to determining that the control target lower layer ECU is in the operation state, the first intermediate layer ECU 20 proceeds to S230. In response to determining that the control target lower layer ECU is not in the operation state, the first intermediate layer ECU 20 proceeds to S260.

In S230, the first intermediate layer ECU 20 receives the NM message transmitted from the control target lower layer ECU. As described above, in the operation state, each of the lower layer ECUs 40, 50, 60 periodically transmits an NM message including PN request information that designates the cluster to which own ECU belongs as the activation target cluster. The first intermediate layer ECU 20 receives the NM message periodically transmitted from the control target lower layer ECU. When a control message is periodically transmitted from the control target lower layer ECU, the first intermediate layer ECU 20 may receive the control message instead of the NM message.

In S240, the first intermediate layer ECU 20 determines whether an elapsed period of time during which reception of the NM message (or the control message) from the control target lower layer ECU is interrupted has reached a predetermined period of time. This predetermined period is set to a period at least longer than the transmission interval of the NM message (or control message) that is periodically transmitted from the control target lower layer ECU. Therefore, when the reception of NM message (or control message) from the target lower layer ECU of the operation state is interrupted for the predetermined period of time or longer, the intermediate layer ECU may assume that an abnormality, such as a CPU runaway, has occurred, causing communication with the control target lower layer ECU to be interrupted.

As another example, a control device other than the first intermediate layer ECU 20 (such as the upper layer ECU 10, the second intermediate layer ECU 30, or the second lower layer ECU 50) may determine whether the NM message (or control message) is being periodically transmitted from the control target lower layer ECU, that is, whether the elapsed time period during which reception of the NM message (or control message) from the control target lower layer ECU is interrupted has reached the predetermined period. In this case, when the control device other than the first intermediate layer ECU 20 determines that the elapsed period of time during which reception of the NM message (or control message) from the control target lower layer ECU has reached the predetermined period of time, the control device other than the first intermediate layer ECU notifies the first intermediate layer ECU 20 of this determination result.

When the elapsed time period during which the reception of NM message from the control target lower layer ECU is interrupted has reached the predetermined period of time, the first intermediate layer ECU proceeds to S250. When the elapsed time period during which the reception of NM message from the control target lower layer ECU is interrupted has not reached the predetermined period of time, the first intermediate layer ECU proceeds to S260.

In S250, the first intermediate layer ECU 20 turns off the relay circuit corresponding to the control target lower layer ECU for a certain period of time. Then, the first intermediate layer ECU 20 turns on the relay circuit again after the certain period of time has elapsed from the turn-off of the relay circuit. This configuration allows the first intermediate layer ECU 20 to forcibly restart the control target lower layer ECU. Thus, the first intermediate layer ECU 20 can reliably prompt the control target lower layer ECU to return to the normal operation. Thereafter, the first intermediate layer ECU 20 proceeds to S260.

In S260, the first intermediate layer ECU 20 determines whether process executed in S210 to S250 described above have been completed for all of the lower layer ECUs 40, 50 that receive power supply via the respective relay circuits 26, 28. In response to determining that the process for all of the lower layer ECUs 40, 50 have been completed, the first intermediate layer ECU 20 ends the process shown in the flowchart of FIG. 4. In response to determining that the process for all of the lower layer ECUs 40, 50 have not yet been completed, the first intermediate layer ECU 20 proceeds to S270.

In S270, the first intermediate layer ECU 20 switches the control target lower layer ECU. Then, the first intermediate layer ECU 20 returns to S210 and repeats the process in S210 to S250 until the process for all of the lower layer ECUs 40, 50 is completed. The process executed in S260 and S270 may be omitted if there is only one lower layer ECU whose power supply is controlled by the intermediate layer ECU via a relay circuit.

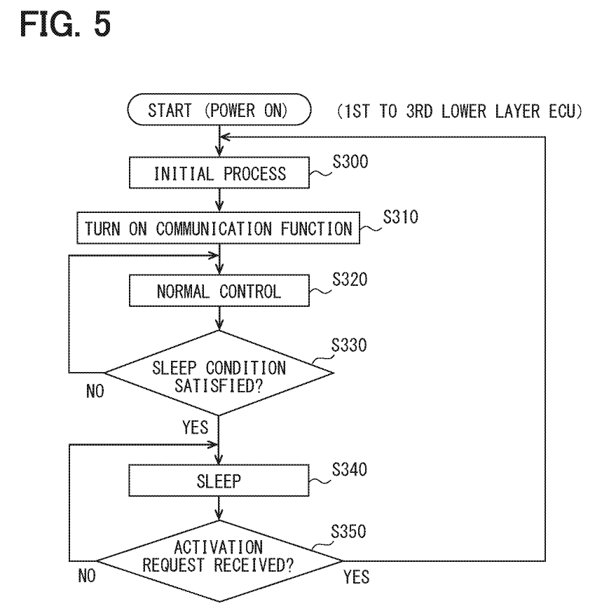

The following will describe a process executed by each of the first to third lower layer ECUs 40, 50, 60. FIG. 5 is a flowchart showing an example of a process executed by the first to third lower layer ECUs 40, 50, 60. When the corresponding relay circuit is turned on and power supply to each of the first to third lower layer ECUs 40, 50, 60 is started, each of the first to third lower layer ECUs 40, 50, 60 executes a process shown in the flowchart of FIG. 5. In the following description, suppose that the first lower layer ECU 40 executes the process shown in the flowchart of FIG. 5 as representative.

In S300, the first lower layer ECU 40 executes an initial process. The initial process includes, for example, initial setting of the hardware and checking the operation of the storage medium. In S310, the first lower layer ECU 40 turns on the communication function. This allows the first lower layer ECU 40 to transmit and receive various messages via the communication IF 42. For example, the first lower layer ECU 40 can periodically transmit an NM message while performing normal control in the operation state.

In S320, the first lower layer ECU 40 executes a predetermined control process, calculation process, drive process, or the like as normal control. In S330, the first lower layer ECU 40 determines whether a sleep condition to switch to the sleep state is satisfied or not. For example, the first lower layer ECU 40 may determine that the condition for switching to the sleep state is satisfied when a predetermined period of time has elapsed since the execution of the predetermined control process, calculation process, or drive process is completed and reception of NM message, which includes PN request information designating the cluster to which the lower layer ECU belongs as the activation target cluster, is interrupted. Upon determining that the condition for switching to the sleep state is satisfied, the first lower layer ECU 40 proceeds to 340. Upon determining that the condition for switching to the sleep state is not satisfied, the first lower layer ECU 40 returns to S320.

In S340, the first lower layer ECU 40 switches to the sleep state. In S350, the first lower layer ECU 40 determines whether the communication IF 42 of the first lower layer ECU 40 has received an NM message including PN request information specifying the cluster to which the first lower layer ECU 40 belongs as the activation target cluster, that is, whether activation of the first lower layer ECU 40 is requested. In response to determining that activation of the first lower layer ECU 40 is requested, the process returns to S300. As a result, the first lower layer ECU 40 is activated and switched to the operation state. When activation of the first lower layer ECU 40 is not requested, the first lower layer ECU 40 continues the sleep state.

### Second Embodiment

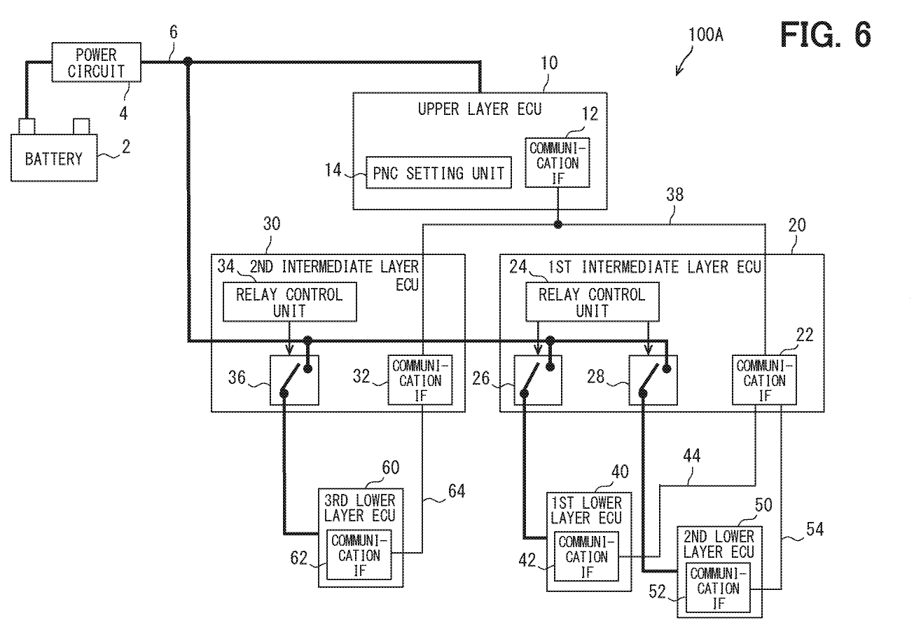

The following will describe a vehicle system 100A and a control method of the vehicle system 100A according to a second embodiment of the present disclosure. FIG. 6 is a diagram showing an exemplary configuration of a vehicle system 100A according to the second embodiment. As shown in FIG. 6, in the vehicle system 100A according to the second embodiment, a PNC setting unit 14 is provided in the upper layer ECU 10 in comparison with the vehicle system 100 according to the first embodiment. The PNC setting unit 14 corresponds to a cluster setting information setting unit of the present disclosure.

The PNC setting unit 14 has a function of resetting the PNC setting information of the first to third lower layer ECUs 40, 50, 60. When the PNC setting unit 14 resets the PNC setting information of the first to third lower layer ECUs 40, 50, 60, the PNC setting unit 14 also resets the PNC setting information of the first to third lower layer ECUs 40, 50, 60 stored in the first and second intermediate layer ECUs 20, 30. The PNC setting unit 14 has a PNC setting table that includes all of the PNC setting information of the first to third lower layer ECUs 40, 50, 60. The PNC setting unit 14 can reset the PNC setting information of the first to third lower layer ECUs 40, 50, 60 based on the PNC setting table.

The PNC setting unit 14 may be provided in the first intermediate layer ECU 20 or in the second intermediate layer ECU 30, instead of the upper layer ECU 10. In response to addition or replacement of the lower layer ECU 40, 50, 60 or the addition of an application to at least one lower layer ECU, it becomes necessary to change the PNC setting information of at least one of the first to third lower layer ECUs 40, 50, 60. The PNC setting unit 14 can obtain an updated PNC setting table, for example, from an external server. Then, the PNC setting unit 14 may change the PNC setting information of the first to third lower layer ECUs 40, 50, 60 to appropriate PNC setting information based on the updated PNC setting table. At this time, the PNC setting unit 14 may reset the PNC setting information of all the lower layer ECUs, or may reset the PNC setting information only for the lower layer ECU whose PNC setting information has been changed.

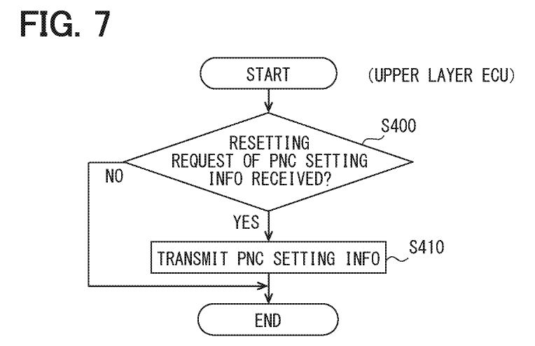

The following will describe an example of process executed by the upper layer ECU 10, the first and second intermediate layer ECUs 20, 30, and the first to third lower layer ECUs 40, 50, 60 in the vehicle system 100A according to the present embodiment with reference to the flowcharts of FIG. 7 to FIG. 9.

Similar to the first embodiment, the upper layer ECU 10 periodically executes the process shown in the flowchart of FIG. 3. In addition, the upper layer ECU 10 periodically executes the process shown in the flowchart of FIG. 7. The process shown in the flowchart of FIG. 7 will be described in detail.

In S400, the upper layer ECU 10 determines whether a request to reset the PNC setting information of the lower layer ECU has been received. In the present embodiment, as described below, when the first and second intermediate layer ECUs 20, 30 have not received an NM message from the operating lower layer ECU for a predetermined period of time, the first and second intermediate layer ECUs 20, 30 transmit a request to reset the PNC setting information of the corresponding lower layer ECU. In response to determining reception of the request for resetting the PNC setting information, the upper layer ECU 10 proceeds to S410. In response to determining that the request for resetting the PNC setting information is not received, the upper layer ECU 10 ends the process shown in the flowchart of FIG. 7.

In S410, the upper layer ECU 10 reads out, from the PNC setting table, the PNC setting information of the lower layer ECU for which the request for resetting the PNC setting information has been received, and then transmits the readout PNC setting information. The PNC setting information transmitted by the upper layer ECU 10 is received by the corresponding lower layer ECU. Then, based on the received PNC setting information, the lower layer ECU resets the PNC setting information. In response to receiving the request to reset the PNC setting information of one lower layer ECU, the upper layer ECU 10 may reset the PNC setting information of all of the lower layer ECUs, or may reset the PNC setting information only for the lower layer ECU for which the request to reset the PNC setting information is received.

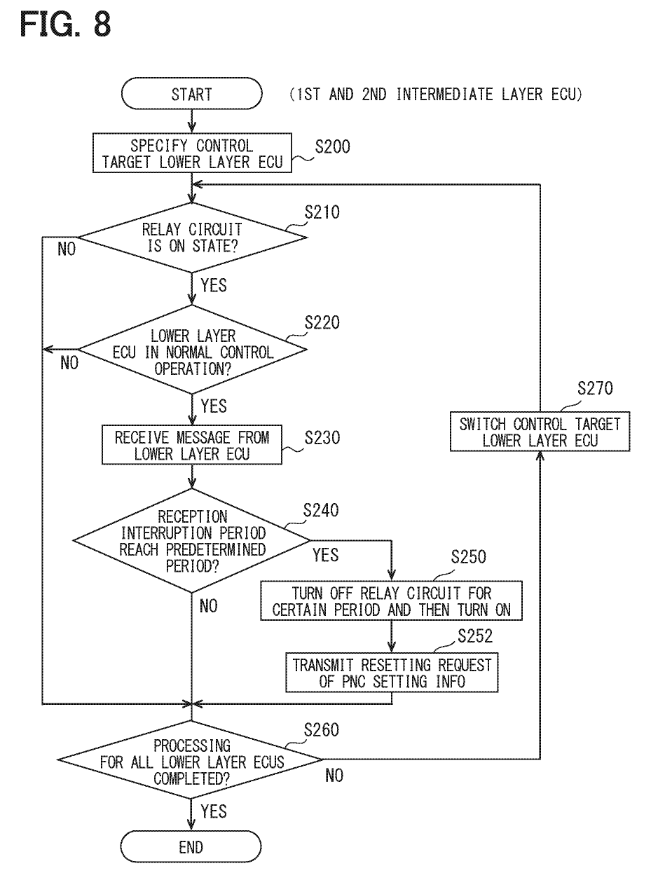

The following will describe a process executed by each of the first and second intermediate layer ECUs 20, 30. FIG. 8 is a flowchart showing an example of process executed by each of the first and second intermediate layer ECUs 20, 30. The first and second intermediate layer ECUs 20, 30 periodically execute the process shown in the flowchart of FIG. 8.

In the flowchart of FIG. 8, S252 is added compared with the flowchart of FIG. 4. Other steps are the same in the flowchart of FIG. 8 and the flowchart of FIG. 4. Therefore, the process of S252 will be mainly explained below.

The process in S252 is executed by each of the first and second intermediate layer ECUs 20, 30 when the reception of the NM message from the lower layer ECU that should be in the operation state is interrupted for a predetermined period of time and thus the relay circuits 26, 28, 36 are turned off for a certain period of time and then turned on again. The process in S252 may be executed after the process of S250 is executed or before execution of the process of S250.

In S252, the first and second intermediate layer ECUs 20, 30 transmit a request to the upper layer ECU 10 to reset the PNC setting information of the corresponding lower layer ECU in response to the elapsed time period for which the reception of NM message from the lower layer ECU in operation state is interrupted reaching a predetermined period.

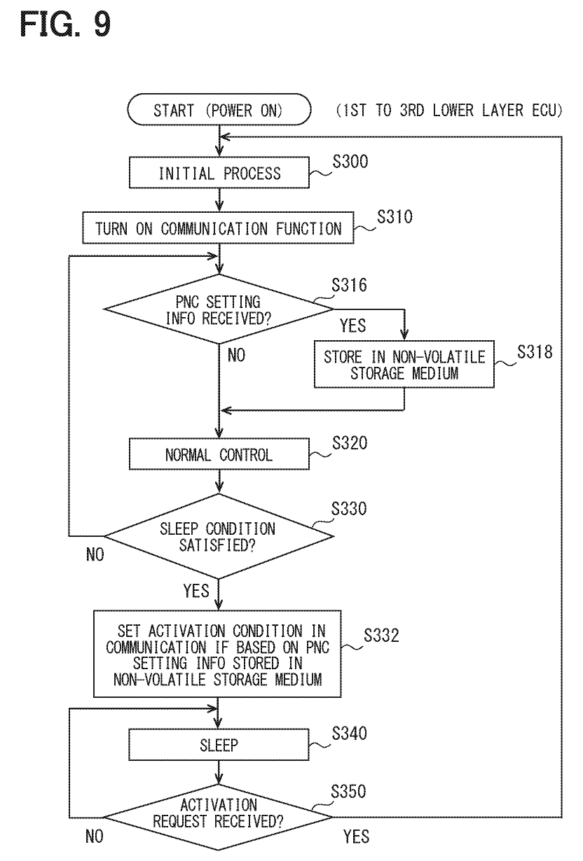

The following will describe a process executed by each of the first to third lower layer ECUs 40, 50, 60. FIG. 9 is a flowchart showing an example of a process executed by the first to third lower layer ECUs 40, 50, 60. When the corresponding relay circuit is turned on and power supply to each of the first to third lower layer ECUs 40, 50, 60 is started, each of the first to third lower layer ECUs 40, 50, 60 executes a process shown in the flowchart of FIG. 9. In the following description, suppose that the first lower layer ECU 40 executes the process shown in the flowchart of FIG. 9 as representative.

In the flowchart of FIG. 9, S316, S318, S332 are added compared with the flowchart of FIG. 5. Other steps are the same in the flowchart of FIG. 9 and the flowchart of FIG. 5. Therefore, the process of S316, S318, S332 will be mainly explained below.

The process of S316 is executed after the communication function of the first lower layer ECU 40 is turned on in S310. In S316, the first lower layer ECU 40 determines whether the PNC setting information transmitted from the upper layer ECU 10 to the first lower layer ECU 40 has been received. In response to determining that the PNC setting information has been received, the first lower layer ECU 40 proceeds to S318. In response to determining that the PNC setting information is not received, the first lower layer ECU 40 proceeds to S320.

The process of S316 is repeatedly executed each time the first lower layer ECU 40 determines in S330 that the condition for switching to the sleep state is not satisfied. That is, the first lower layer ECU 40 repeatedly executes the process of S316 in the operation state.

In S318, the first lower layer ECU 40 stores the received PNC setting information in a non-volatile storage medium. At this time, the lower layer ECU may store the received PNC setting information by overwriting the existing PNC setting information. Alternatively, the received PNC setting information may be written to a storage area different from that of the existing PNC setting information. In this case, since multiple pieces of PNC setting information are stored in the non-volatile storage medium, it is necessary to identify the latest PNC setting information.

The process of S332 is executed after the condition for switching to the sleep state of the first lower layer ECU 40 is satisfied, but before the first lower layer ECU 40 actually switches to the sleep state. In S332, the first lower layer ECU 40 sets, for the communication IF 42, cluster information functioning as the activation condition, based on the PNC setting information stored in the non-volatile storage medium. As a result, when the PNC setting information is reset, the cluster information functioning as the activation condition can be set in the communication IF 42 based on the reset PNC setting information. While the first lower layer ECU 40 is in the sleep state, the communication IF 42 determines whether the received NM message includes the PN request information that matches the cluster information set in S332.

When an abnormality occurs in any one of the lower layer ECUs, such as the loss or corruption of the PNC setting information stored in the non-volatile storage medium, the normal activation of lower layer ECU by the NM message may be failed. In this case, the lower layer ECU maintains the sleep state even though it should be switched to the operation state.

In the present embodiment, the first or second intermediate layer ECU 20, 30 transmit a request to the upper layer ECU 10 to reset the PNC setting information of the corresponding lower layer ECU in response to the elapsed time period for which the reception of NM message from the lower layer ECU in operation state is interrupted reaching a predetermined period of time. In response to the resetting request, the upper layer ECU 10 reads out, from the PNC setting table, the PNC setting information of the lower layer ECU for which the request for resetting the PNC setting information has been received, and then transmits the readout PNC setting information. The PNC setting information transmitted from the upper layer ECU is received by the corresponding lower layer ECU and stored in a non-volatile storage medium. In response to receiving the NM message, the communication IF of the corresponding lower layer ECU determines whether to activate own ECU in accordance with the activation condition according to the latest PNC setting information stored in the non-volatile storage medium.

Therefore, even when an abnormality such as loss or corruption of the PNC setting information stored in the non-volatile storage medium occurs, it is possible to restore the PNC setting information. As a result, the NM message enables the lower layer ECU to be activated normally.

### Third Embodiment

The following will describe a vehicle system 100A and a control method of the vehicle system 100A according to a third embodiment of the present disclosure. The vehicle system 100A according to the present embodiment has a similar configuration to the vehicle system 100A according to the second embodiment. Therefore, a detailed description of the configuration of the vehicle system 100A according to the third embodiment will be omitted.

In the second embodiment, the first and second intermediate layer ECUs 20, 30 transmit a request to the upper layer ECU 10 to reset the PNC setting information of the corresponding lower layer ECU in response to determining that the elapsed time period for which the reception of NM message from the lower layer ECU in operation state is interrupted reaches a predetermined period of time. In the present embodiment, each of the first to third lower layer ECUs 40, 50, 60 transmits, to the upper layer ECU 10, a request to reset the PNC setting information in response to the relay circuit 26, 28, 36 being turned on and power supply being started.

In the present embodiment, each of the first to third lower layer ECUs 40, 50, 60 has an activation factor determination function that determines whether the activation is caused by turn-on of the relay circuit 26, 28, 36 to start the power supply, or the activation is caused by reception of an NM message. When each of the first to third lower layer ECUs 40, 50, 60 determine that the activation is caused by turn-on of the relay circuit 26, 28, 36 to start the power supply, the lower layer ECU transmits a request to reset the PNC setting information to the upper layer ECU 10.

The activation factor determination function of the first to third lower layer ECUs 40, 50, 60 can be implemented, for example, by determining whether the variables set to initial values remain at their initial values when the first to third lower layer ECUs 40, 50, 60 are activated by turning on the relay circuits 26, 28, 36 to start the power supply. For example, the values of registers (for example, program counters, address registers) in the first to third lower layer ECUs 40, 50, 60 and the memory of the communication IFs 42, 52, 62 may be reset to their initial values when the relay circuits 26, 28, 36 are turned on to start the power supply for activating the ECUs. The values of the registers and memories may change from their initial values when the first to third lower layer ECUs 40, 50, 60 start operation or when messages are transmitted and received. When the first to third lower layer ECUs 40, 50, 60 switch to the sleep states, the power supply to the first to third lower layer ECUs 40, 50, 60 is maintained so that the values of registers and memories that have changed from their initial values are maintained as the current values. Therefore, when the values in the registers and memories are the initial values, the first to third lower layer ECUs 40, 50, 60 can determine that they have activated in response to turn-on of the relay circuits 26, 28, 36 to start the power supply. When the values in the registers or memories of the first to third lower layer ECUs 40, 50, 60 are other than the initial values, it can be determined that the first to third lower layer ECUs 40, 50, 60 are activated in response to reception of an NM message.

The activation factor determination function of the first to third lower layer ECUs 40, 50, 60 can also be implemented by determining whether data used for processing during normal operation is stored in a volatile memory such as a main memory. When the data used for processing is not stored in the volatile memory, the first to third lower layer ECUs 40, 50, 60 can determine that they are activated in response to turn-on of the relay circuits 26, 28, 36 to start the power supply. When the data used for processing is stored in the volatile memory, the first to third lower layer ECUs 40, 50, 60 can determine that they have activated in response to reception of an NM message.

The activation factor determination function of the first to third lower layer ECUs 40, 50, 60 can be implemented by determining whether information indicating the reception of an NM message (for example, a reception flag) is included in the communication IF. When there is no information indicating the reception of an NM message in the communication IF, the first to third lower layer ECUs 40, 50, 60 can determine that the activation is caused by turn-on of the relay circuits 26, 28, 36 to start the power supply. When there is information indicating the reception of an NM message in the communication IF, the first to third lower layer ECUs 40, 50, 60 can determine that the activation is caused by the reception of an NM message.

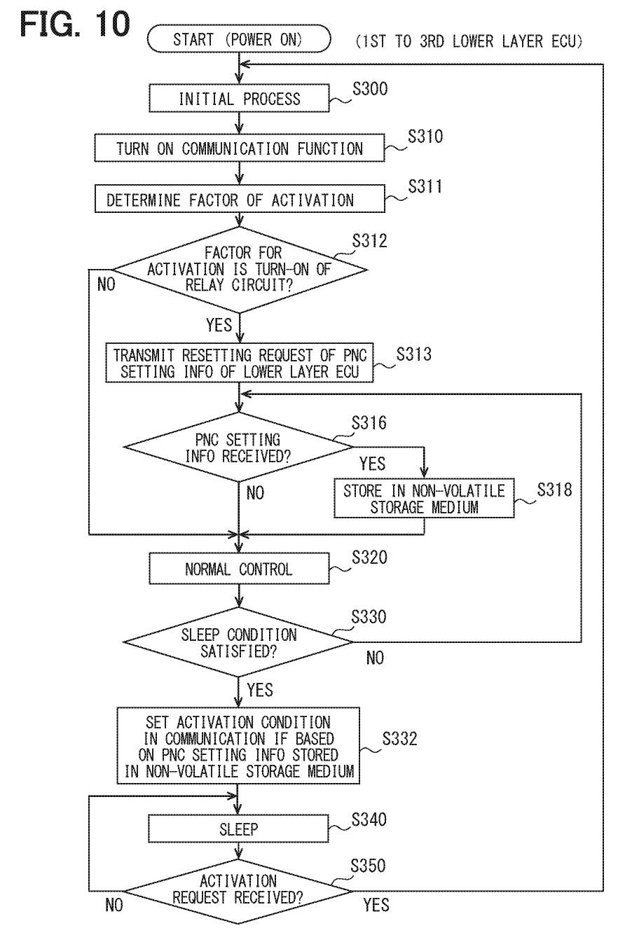

An example of the process executed by the first to third lower layer ECUs 40, 50, 60 in the vehicle system 100A according to the present embodiment will be described with reference to the flowchart of FIG. 10. The process executed by the upper layer ECU 10 is the same as that in the second embodiment. The processes executed by the first and second intermediate layer ECUs 20, 30 are the same as those in the first embodiment.

In the flowchart of FIG. 10, S311, S312, S313 are added compared with the flowchart of FIG. 9. Other steps are the same in the flowchart of FIG. 10 and the flowchart of FIG. 9. Therefore, the process of S311, S312, S313 will be mainly explained below.

In S311, each of the first to third lower layer ECUs 40, 50, 60 determines, using the activation factor determination function, whether the activation is caused by turn-on of the relay circuit 26, 28, 36 to start the power supply, or the activation is caused by reception of an NM message. In S312, the process determines whether the activation factor specified in S311is that the activation is caused by turn-on of the relay circuit 26, 28, 36 to start the power supply, In response to determining that the activation factor is the start of power supply by turn-on of the relay circuits 26, 28, 36, the first to third lower layer ECUs 40, 50, 60 proceed to S313. In response to determining that the activation factor is not the start of power supply by turn-on of the relay circuits 26, 28, 36, the first to third lower layer ECUs 40, 50, 60 proceed to S320.

In S313, each of the first to third lower layer ECUs 40, 50, 60 transmits, to the upper layer ECU 10, a request to reset own PNC setting information. When the upper layer ECU 10 receives the request to reset the PNC setting information from at least one of the first to third lower layer ECUs 40, 50, 60, the upper layer ECU 10 transmits the PNC setting information to at least the corresponding lower layer ECU that has transmitted the resetting request. This configuration enables resetting of the PNC setting information in the first to third lower layer ECUs 40, 50, 60.

### Modifications

The present disclosure is not limited to the above-described embodiments. In addition to the above-described embodiments, the present disclosure can be implemented in various modifications within the scope of the spirit of the present disclosure.

### First Modification

In the second and third embodiments described above, when resetting the PNC setting information of the first to third lower layer ECUs 40, 50, 60, the upper layer ECU 10 reads out the PNC setting information of the corresponding lower layer ECU from the PNC setting table and transmits the readout PNC setting information. In this case, the PNC setting information of the first to third lower layer ECUs 40, 50, 60 is reset to the default PNC setting information.

The upper layer ECU 10 may reset the PNC setting information of the first to third lower layer ECUs 40, 50, 60, to be different from the default PNC setting information. For example, the PNC setting information different from the default PNC setting information may be reset so that the corresponding lower layer ECU belongs to at least one cluster. In this case, the PNC setting information of the lower layer ECU may be reset such that the corresponding lower layer ECU belongs to all clusters. With this configuration, it is possible to increase an activation chance of the lower layer ECU by reception of an NM message.

When the communication between the lower layer ECU and the intermediate layer ECU is restored as a result of resetting the PNC setting information of the lower layer ECU to be different from the default PNC setting information, the abnormality occurred in the lower layer ECU may be determined as temporary abnormality and the abnormality may be considered to be resolved by restoring of the communication. In response to determining that the abnormality is determined to be resolved, the upper layer ECU 10 resets the PNC setting information of the lower layer ECU to the default PNC setting information. This configuration allows the lower layer ECU to be activated at the time when the lower layer ECU is required to operate.

### Second Modification

In the third embodiment described above, the first to third lower layer ECUs 40, 50, 60 transmit a request to reset the PNC setting information to the upper layer ECU 10 in response to determining that they are activated by turn-on of the relay circuits 26, 28, 36. In addition, each of the first to third lower layer ECUs 40, 50, 60 may determine whether the PNC setting information set in own ECU is appropriate. In response to determining that the PNC setting information set in own ECU is not appropriate, each of the first to third lower layer ECUs 40, 50, 60 may transmit a request to the upper layer ECU 10 to reset the PNC setting information. For example, when the PNC setting information set in the first to third lower layer ECUs 40, 50, 60 indicates that the lower layer ECU belongs to no cluster, the first to third lower layer ECUs 40, 50, 60 can determine that the PNC setting information is not appropriate.

### Third Modification

The systems and methods described in the present disclosure may be implemented by a special purpose computer comprising a processor programmed to perform one or more functions embodied in a computer program. The systems and methods described in the present disclosure may be implemented using dedicated hardware logic circuitry. The systems and methods described in the present disclosure may be implemented by one or more special purpose computers comprising a combination of a processor executing a computer program and one or more hardware logic circuits. For example, some or all of the functions provided by the upper layer ECU 10, the first and second intermediate layer ECUs 20, 30, and the first to third lower layer ECUs 40, 50, 60 may be implemented as hardware. A configuration in which a certain function is implemented by hardware logic circuitry includes a configuration in which the function is implemented using one or more ICs or the like. Some or all of the functions provided by the upper layer ECU 10, the first and second intermediate layer ECUs 20, 30, and the first to third lower layer ECUs 40, 50, 60 may be implemented using any of a system-on-chip (SoC), an integrated circuit (IC), or a field-programmable gate array (FPGA). The concept of IC includes ASIC (Application Specific Integrated Circuits). The computer program described above may be stored in a computer-readable non-transitory tangible storage medium as instructions to be executed by a computer. As a storage medium for storing the computer program, a hard disk drive (i.e., HDD), a solid state drive (i.e., SSD), a flash memory, or the like can be adopted. Furthermore, a program for causing a computer to function as the upper layer ECU 10, the first and second intermediate layer ECUs 20, 30, and the first to third lower layer ECUs 40, 50, 60, as well as non-transitory tangible storage medium such as semiconductor memory or the like on which such a program is stored, are also included within the scope of the present disclosure.

What is claimed is:

1. A vehicle system comprising a plurality of control devices mounted on a vehicle,
wherein
the plurality of control devices include at least one lower layer control device and at least one upper layer control device,
the at least one upper layer control device has a relay control unit that turns on or turns off a relay circuit provided in a power supply line of the at least one lower layer control device,
the plurality of control devices further include at least one communication partner control device with which the at least one lower layer control device is communicatively connected via a communication bus, and
the at least one upper layer control device is configured to, in response to a communication between the at least one communication partner control device and the at least one lower layer control device for which the relay circuit has been turned on being interrupted for a predetermined period of time, turn off the relay circuit using the relay control unit and then turn on the relay circuit using the relay control unit.

2. The vehicle system according to claim 1, wherein
the at least one upper layer control device has a determination unit configured to determine whether the at least one lower layer control device is in an operation state, and
when the determination unit determines that the at least one lower layer control device is in the operation state, the at least one upper layer control device determines whether a communication with the at least one lower layer control device has been interrupted for a predetermined period of time.

3. The vehicle system according to claim 1, wherein
the at least one upper layer control device is communicably connected to the at least one lower layer control device as the at least one communication partner control device,
the at least one upper layer control device receives a message from the at least one lower layer control device, and
when the at least one upper layer control device fails to receive the message from the at least one lower layer control device for the predetermined period of time, the at least one upper layer control device determines that the communication with the at least one lower layer control device is interrupted for the predetermined period of time.

4. The vehicle system according to claim 1, wherein
one of the plurality of control devices other than the at least one upper layer control device is communicably connected to the at least one lower layer control device as the at least one communication partner control device,
the at least one communication partner control device receives a message from the at least one lower layer control device, and
when the at least one communication partner control device fails to receive the message from the at least one lower layer control device for the predetermined period of time, the at least one communication partner control device notifies a reception failure of the message to the at least one upper layer control device.

5. The vehicle system according to claim 1, wherein
the at least one lower layer control device stores cluster setting information indicating a cluster assigned to own control device among multiple clusters classified in advance, and
the at least one lower layer control device wakes up from a sleep state and switches to an operation state in response to receiving a network management message, which includes activation target cluster information indicating the cluster set in own cluster setting information as an activation target cluster.

6. The vehicle system according to claim 5, further comprising
a cluster setting information setting unit configured to reset the cluster setting information stored in the at least one lower layer control device in response to the relay control unit turning off the relay circuit and then turning on the relay circuit.

7. The vehicle system according to claim 5, further comprising
a cluster setting information setting unit configured to reset the cluster setting information stored in the at least one lower layer control device in response to receiving a request to reset the cluster setting information from the at least one lower layer control device.

8. The vehicle system according to claim 7, wherein
the at least one lower layer control device is configured to determine whether own control device is activated in response to receiving the network management message or a start of power supply by turning on the relay circuit, and
the at least one lower layer control device transmits the request to reset the cluster setting information to the cluster setting information setting unit in response to determining that own control device is activated in response to the start of power supply.

9. The vehicle system according to claim 8, wherein
the at least one lower layer control device determines whether own control device is activated in response to receiving the network management message or the start of power supply, based on at least one of
(i) whether variables, which are controlled to reset to initial values in response to the start of power supply, have the initial values,
(ii) whether data, which is used by a process executed during a normal operation, is stored in a volatile memory, or
(iii) whether there is information indicating that the network management message is received.

10. The vehicle system according to claim 6, wherein
the cluster setting information setting unit resets the cluster setting information stored in the at least one lower layer control device such that the at least one lower layer control device belongs to at least one cluster among the multiple clusters classified in advance.

11. The vehicle system according to claim 6, wherein
the cluster setting information setting unit resets the cluster setting information stored in the at least one lower layer control device such that the at least one lower layer control device belongs to all of the multiple clusters classified in advance.

12. The vehicle system according to claim 11, wherein,
after a communication interruption between the at least one upper layer control device and the at least one lower layer control device is resolved as a result of setting the cluster setting information stored in the at least one lower layer control device, the cluster setting information setting unit sets the cluster setting information stored in the at least one lower layer control device to default cluster setting information.

13. A control method of a vehicle system, the vehicle system including a plurality of control devices mounted on a vehicle, the plurality of control devices including at least one lower layer control device and at least one upper layer control device, the at least one upper layer control device having a relay control unit that turns on or turns off a relay circuit provided in a power supply line of the at least one lower layer control device, and the plurality of control devices further including at least one communication partner control device with which the at least one lower layer control device is communicatively connected via a communication bus,
the control method of the vehicle system comprising:
determining whether a communication between the at least one communication partner control device and the at least one lower layer control device for which the relay circuit has been turned on is interrupted for a predetermined period of time; and
in response to determining that the communication between the at least one communication partner control device and the at least one lower layer control device is interrupted for the predetermined period of time, turning off the relay circuit using the relay control unit and then turning on the relay circuit using the relay control unit.
